(19) United States
(12) Patent Application Publication
(10) Pub. No.: US 2002/0180576 A1
(43) Pub. Date: Dec. 5, 2002

(54) Chip thermistor and chip thermistor mounting structure

(75) Inventors: Satoshi Kumura, Shiga-ken (JP); Hidehiro Inoue, Omihachiman-shi (JP)

Correspondence Address: Keating & Bennett LLP, Suite 312, 10400 Eaton Place, Fairfax, VA, 22030, US

(73) Assignee: Murata Manufacturing Co., Ltd., Nagaokakyo-shi (JP)

(21) Appl. No.: 10/155,734

(22) Filed: May 28, 2002

(30) Foreign Application Priority Data
Jun. 1, 2001 (JP) 2001-167005
Mar. 13, 2002 (JP) 2002-068507
Feb. 4, 2002 (JP) 2002-027163

(51) Int. Cl. H01C 7/10

(52) U.S. Cl. 338/22 R; 338/314; 338/313

(57) ABSTRACT

A chip thermistor includes a chip element assembly having a substantially rectangular shape and three pairs of side surfaces facing each other, and a pair of external electrodes each having a main electrode portion and a side-surface electrode portion, wherein the external electrodes have gaps therebetween, each main electrode portion is disposed on each of a first pair of the side surfaces having a substantially rectangular shape, each side-surface electrode portion is disposed on an end portion of each of four side surfaces which define a second and third pair of the side surfaces, the end portion that is connected with each of the first pair of the substantially rectangular side surfaces each having the main electrode portion thereon, and each of the gaps is on each of the four side surfaces.

### BACKGROUND OF THE INVENTION

1. Field of the Invention

The present invention relates to chip thermistors such as positive-temperature-coefficient thermistors and negative-temperature-coefficient thermistors, and more particularly, the present invention relates to a chip thermistor having a small resistance and to a chip-thermistor mounting structure.

2. Description of the Related Art

In accordance with the miniaturization of electronic devices, the chip thermistor used for the electronic devices must be connected to a circuit board by soldering.

FIG. 6 shows a conventional chip thermistor 1. The chip thermistor 1 has a chip element assembly 2 having a rectangular shape and external electrodes 3a and 3b each completely covering an end surface of the chip element assembly 2 and each covering end portions of four side surfaces connected to a respective one of end surfaces.

Among chip thermistors, a positive-temperature-coefficient thermistor will now be described. The positive-temperature-coefficient thermistor is used as an overcurrent protection element for protecting an electric circuit from overcurrent. In this use, positive-temperature-coefficient thermistors having a small resistance are required to reduce the amount of electric loss due to voltage drop.

FIG. 7 shows a positive-temperature-coefficient thermistor satisfying the above requirement and having a small resistance. In FIG. 7, portions similar to those in FIG. 6 have corresponding reference numerals which are the same as those in FIG. 6. The chip positive-temperature-coefficient thermistor 1′ has a chip element assembly 2 and external electrodes 3a′ and 3b′, wherein the external electrodes 3a′ and 3b′ are disposed so as to completely cover the two shorter side or end surfaces of the chip element assembly 2, and are close to each other at an approximate center of the four longer side surfaces of the chip element assembly 2. In this structure, each of the external electrodes 3a′ and 3b′ has a large surface area to reduce the resistance of the chip positive-temperature-coefficient thermistor 1′.

In the chip positive-temperature-coefficient thermistor 1′ shown in FIG. 7, since the external electrodes 3a′, and 3b′ are disposed close to each other at an approximate center of the four longer side surfaces, the following problems arise when such a thermistor is mounted on a circuit board by soldering: formation of a short circuit between the external electrodes 3a′ and 3b′, a reduction in the dielectric strength, and migration.

### SUMMARY OF THE INVENTION

In order to overcome the problems described above, preferred embodiments of the present invention provide a chip thermistor having a very small resistance and that readily dissipates heat when voltage is applied.

A chip thermistor according to a preferred embodiment of the present invention includes a chip element assembly having a substantially rectangular shape and three pairs of side surfaces facing each other, the three pairs of side surfaces including a first pair of longer substantially rectangular side surfaces, a second pair of longer substantially rectangular side surfaces, and a third pair of shorter substantially square side surfaces, and a pair of external electrodes each having a main electrode portion and a side-surface electrode portion, wherein the external electrodes have gaps therebetween, each main electrode portion is disposed on each of the first pair of the longer substantially side surfaces, each side-surface electrode portion is disposed on an end portion of each of the second and third pair of side surfaces, the end portion that is connected with each of the first pair of the longer substantially rectangular side surfaces each having the main electrode portion thereon, and each of the gaps is located on each of the second and third pair of side surfaces.

In the chip thermistor, a pair of the longer substantially rectangular side surfaces having the main electrode portions thereon each have an area that is larger than that of the other two pairs of the side surfaces.

In the chip thermistor, each of the external electrodes preferably includes a base electrode and a soldering electrode disposed thereon. The base electrode is partially exposed at the end of the soldering electrodes. The base electrode has ohmic contact and does not have solder wettability. The soldering electrode has solder wettability.

A chip thermistor mounting structure of a second preferred embodiment of the present invention includes a circuit board having a connection land and a chip thermistor having external electrodes, wherein the chip thermistor is one of preferred embodiments described above, and the external electrodes are electrically connected to the connection land via solder, wherein one of the four side surfaces is connected to the connection land, the four side surfaces being connected with each of the substantially rectangular side surfaces on which the main electrode portion is disposed.

Thus, the external electrodes individually have a sufficiently large surface area to reduce the resistance of the chip positive-temperature-coefficient thermistor without having to dispose the external electrodes closely which may result in a short circuit being formed.

The external electrodes of the chip thermistor according to preferred embodiments of the present invention each have a main electrode portion and side-surface electrode portions, wherein the main electrode portion is disposed on each of a pair of substantially rectangular side surfaces among three pairs of the side surfaces of the chip element assembly, the substantially rectangular side surfaces face each other and include the longest sides of the chip element assembly having a substantially rectangular shape, and the side-surface electrode portions are individually disposed on an end area of each of the four side surfaces connected with each of the substantially rectangular side surfaces on which the main electrode portions are disposed. In the external electrodes, a gap is situated between end surfaces of the side-surface electrode portions on the four side surfaces. Thus, since the electrodes have large areas, chip thermistors having small resistance are provided.

Since electrodes having a large area readily dissipate heat, a large current can be applied without exerting the thermistor property. Thus, chip thermistor in which increase in the temperature of an element is minimized during the application of voltage is provided.

Other features, elements, characteristics and advantages of the present invention will become more apparent from the following detailed description of the present invention with reference to the attached drawings.

### BRIEF DESCRIPTION OF THE DRAWINGS

FIG. 1 is a perspective view showing a chip positive-temperature-coefficient thermistor of a first preferred embodiment according to the present invention;

FIG. 2 is a sectional view taken along the line I-I of FIG. 1 showing the chip positive-temperature-coefficient thermistor according to a preferred embodiment of the present invention;

FIG. 3 is a perspective view showing a chip positive-temperature-coefficient thermistor of a second preferred embodiment according to the present invention;

FIG. 4 is a sectional view taken along the line II-II of FIG. 3 showing the chip positive-temperature-coefficient thermistor according to the second preferred embodiment of the present invention;

FIG. 5 is a sectional view showing a structure in which the chip positive-temperature-coefficient thermistor shown in FIG. 1 is mounted on a circuit board;

FIG. 6 is a perspective view showing a known chip positive-temperature-coefficient thermistor; and

FIG. 7 is a perspective view showing another known chip positive-temperature-coefficient thermistor.

### DETAILED DESCRIPTION OF PREFERRED EMBODIMENTS

A chip positive-temperature-coefficient thermistor according to a first preferred embodiment of the present invention will now be described with reference to FIGS. 1 and 2.

As shown in FIG. 1, the chip positive-temperature-coefficient thermistor 11 is provided with a chip element assembly 12 preferably having a substantially rectangular shape. The chip element assembly 12 has the following three pairs of side surfaces facing each other: a first pair of side surfaces 12a and 12b, a second pair of side surfaces 12c and 12d, and a third pair of side surfaces 12e and 12f. The first pair of side surfaces 12a and 12b and the second pair of side surfaces 12c and 12d define four longer side surfaces having a substantially rectangular shape, whereas the third pair of side surfaces define two shorter side surfaces having a substantially square shape. The dimensions of the chip element assembly 12 are, for examples approximately 0.8 mm×0.8 mm×1.6 mm.

The chip element assembly 12 has external electrodes 13a and 13b. The external electrodes 13a and 13b have main electrode portions disposed on the first pair of side surfaces 12a and 12b facing each other, respectively. As seen in FIG. 1, the first pair of side surfaces 12a and 12b are preferably completely covered by the main electrode portions of the external electrodes 13a and 13b. The external electrodes 13a and 13b further have side-surface electrode portions disposed on the end areas of the four side surfaces 12c, 12d, 12e, and 12f that are connected with the side surfaces 12a and 12b. Thus, the side-surface electrode portions do not completely cover the second side surfaces 12c and 12d, and the third side surfaces 12e and 12f, but instead a gap is defined between the external electrodes 13a, 13b on each of the shorter substantially square side surfaces 12e, 12f and each of the longer substantially rectangular side surfaces 12c, 12d.

In the external electrodes 13a and 13b, the main electrode portions are individually disposed on the first pair of side surfaces 12a and 12b, respectively, which face each other. The main electrode portions individually have a substantially rectangular shape and dimensions of, for example, 0.8 mm×1.6 mm in this case, and include the longest sides of the chip element assembly 12. The external electrodes 13a and 13b individually have each of the main electrode portions disposed on the side surfaces 12a and 12b and the side-surface electrode portions are individually disposed on each end area of the four side surfaces 12c, 12d, 12e, and 12f connected with both of the side surfaces 12a and 12b.

A gap is situated between the side-surface electrode portions on the four side surfaces 12c, 12d, 12e, and 12f. The gap has a width w of, for example, about 0.2 mm.

As shown in FIG. 2, the external electrodes 13a and 13b preferably include base electrodes 13a1 and 13b1 having ohmic contact, and soldering electrodes 13a2 and 13b2 disposed thereon and having solder wettability. The base electrodes 13a1 and 13b1 are preferably formed by depositing Cr and the soldering electrodes 13a2 and 13b2 are preferably formed by performing electrolytic plating with Sn having excellent solderability.

The base electrodes 13a1 and 13b1 may be a metal having ohmic contact and such a metal includes Ni, Al, and Ti in addition to Cr mentioned above. Other suitable material may also be used to form the base electrodes 13a1 and 13b1. The method of forming the base electrodes 13a1 and 13b1 may preferably include sputtering, deposition, and printing of a conductive paste, and a multilayer including base electrodes formed by the above method may be used.

When the external electrodes 13a and 13b individually have a large thickness, differences in levels between the external electrodes 13a and 13b and the chip element assembly 12 are large, thereby causing the mounting apparatus to fail to catch a chip during mounting of a circuit board. Thus, the external electrodes 13a and 13b preferably have a thickness of about 10 μm or less individually and are preferably formed by a thin-film forming method such as deposition, sputtering, and plating, or other suitable method.

When the width of the gap between the external electrodes 13a and 13b is excessively small, the external electrodes 13a and 13b are bridged by solder to cause a short circuit during mounting of a circuit board. Thus, the width of the gap is preferably at least about 0.2 mm in preferred embodiments of the present invention.

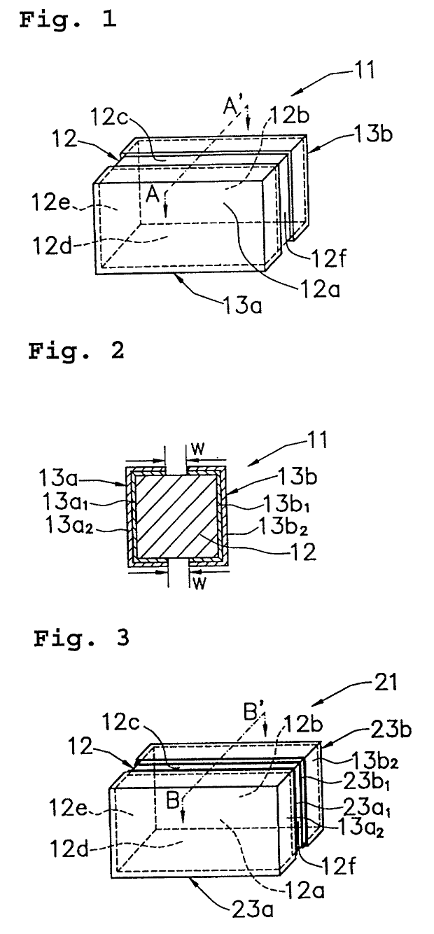

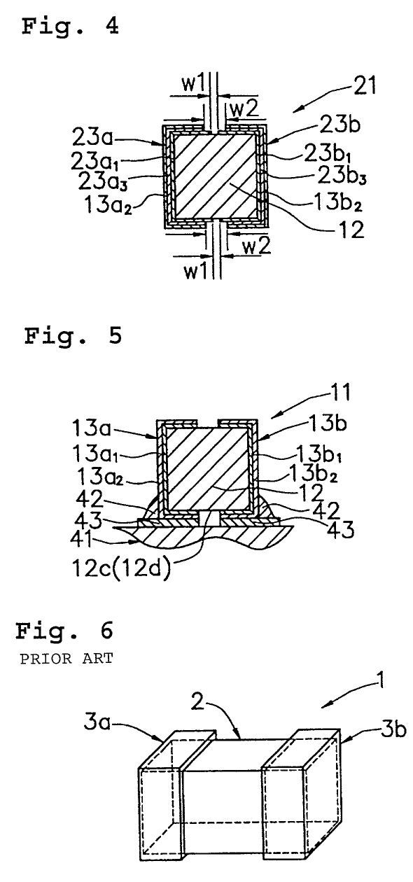

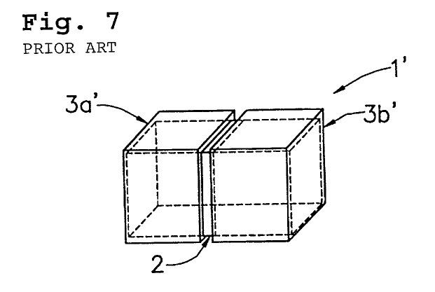

A chip positive-temperature-coefficient thermistor according to a second preferred embodiment of the present invention will now be described with reference to FIGS. 3 and 4. The same portions as those of the chip positive-temperature-coefficient thermistor 11 shown in FIGS. 1 and 2 have the same reference numerals as those in FIGS. 1 and 2, and detailed description thereof is omitted.

Referring to FIG. 3, a chip positive-temperature-coefficient thermistor 21 has a chip element assembly 12 and external electrodes 23a and 23b provided thereon.

Referring to FIG. 4, the external electrodes 23a and 23b preferably include base electrodes 23a1 and 23b1 having ohmic contact, intermediate electrodes 23a3 and 23b3 for preventing solder erosion, and soldering electrodes 13a2 and 13b2 having solder wettability. The intermediate electrodes 23a3 and 23b3 are disposed on the base electrodes 23a1 and 23b1 and the soldering electrodes 13a2 and 13b2 are disposed on the intermediate electrodes 23a3 and 23b3. The side-surface electrode portions of the intermediate electrodes 23a3 and 23b3 individually have an area that is smaller than that of each side-surface electrode portions of the base electrodes 23a1 and 23b1. That is, the base electrodes 23a1 and 23b1 are partially exposed at the ends of the soldering electrodes 13a2 and 13b2.

The base electrodes 23a1 and 23b1 are preferably formed by depositing Cr, the intermediate electrodes 23a3 and 23b3 are preferably formed by depositing Ni—Cu, and the soldering electrodes 13a2 and 13b2 are preferably formed by the electrolytic plating of Sn having excellent solderability.

In the external electrodes 23a and 23b, there are gaps between end surfaces of the side-surface electrode portions on the four side surfaces 12c, 12d, 12e, and 12f of the chip element assembly 12. The gap between the base electrodes 23a1 and 23b1 has a width w1 of, for example, about 0.1 mm, and another gap between the soldering electrodes 13a2 and 13b2 and between intermediate electrodes 23a3 and 23b3 has a width w2 of, for example, about 0.2 mm. In such a structure, the base electrodes 23a1 and 23b1 are partially exposed at the ends of the soldering electrodes 13a2 and 13b2.

The base electrodes 23a1 and 23b1 may include a metal having ohmic contact and not having solder wettability, and such a metal includes Ni, Al, and Ti and/or an alloy thereof in addition to Cr described above.

Now, examples of preferred embodiments of the present invention will be described.

The following samples were fabricated to measure the resistance: a first sample of the chip positive-temperature-coefficient thermistor 11 according to the first preferred embodiment, a second sample of the chip positive-temperature-coefficient thermistor 21 according to the second preferred embodiment, and a comparative sample of the chip positive-temperature-coefficient thermistor 1 according to a conventional method. In the sample of the first preferred embodiment, the sample of the second preferred embodiment, and the comparative sample, the chip element assembly 2 had a dimension of approximately 0.8 mm×0.8 mm×1.6 mm, the gap between the external electrodes had a width of about 0.2 mm. The ceramic used had a resistivity of about 2.5 Ωcm.

The comparative sample had a resistance of 15.4 Ω and the sample of the first preferred embodiment had a resistance of about 7.9 Ω, that is, much smaller than that of the comparative sample. The sample of the second preferred embodiment had a resistance of about 5.8 Ω, that is, smaller than that of the sample of the first preferred embodiment.

Since the external electrodes 13a and 13b of the sample of the first preferred embodiment have a larger area than that the external electrodes 3a and 3b of the comparative sample, respectively, the sample of the first preferred embodiment has a resistance smaller than that of the comparative sample.

Since the width w1 of the gap between the base electrodes 23a1 and 23b1 of the sample of the second preferred embodiment is smaller than that of the gap between the external electrodes 3a and 3b of the comparative sample, the sample of the second preferred embodiment has a resistance that is smaller than that of the comparative sample. When a metal having ohmic contact and not having solder wettability is used for the base electrodes 23a1 and 23b1, the width w1 may be about 0.2 mm or less because the base electrodes 23a1 and 23b1 are not bridged with solder. Thus, a chip positive-temperature-coefficient thermistor having much smaller resistance can be produced.

In the above examples, the main electrode portions of the external electrodes 13a and 13b or other external electrodes 23a and 23b are individually disposed on the longer substantially rectangular side surfaces 12a and 12b, respectively, which are one pair of the two pairs of the side surfaces including the longer sides of the chip element assembly 12 and facing each other. The main electrode portions may be disposed on the other longer substantially rectangular side surfaces 12c and 12d.

In the chip element assembly 12, when the width, length, and height are different, the main electrode portions of the external electrodes 13a and 13b or the external electrodes 23a and 23b are preferably disposed individually on one pair of the substantially rectangular side surfaces having an area larger than those of other two pair of the side surfaces. In such a structure, the external electrodes 13a and 13b or the external electrodes 23a and 23b individually have a large area.

FIG. 5 shows a structure in which the chip positive-temperature-coefficient thermistor 11 is mounted on a circuit board 41 with solder 42. In the structure, the external electrodes 13a and 13b are joined to a connection land 43 with solder 42. In the three pairs of the facing side surfaces of the chip element assembly 12, one of the four side surfaces 12c, 12d, 12e, and 12f is joined to the connection land 43, wherein the four side surfaces 12c, 12d, 12e connect with the substantially rectangular side surfaces 12a, 12b having the main electrode portions of the external electrodes 13a and 13b thereon. In FIG. 5, the side surface 12c or 12d is connected to the connection land 43.

In the above examples, the positive-temperature-coefficient thermistors are described. Negative-temperature-coefficient thermistors having small resistance and readily dissipating heat from an element can be obtained by manufacturing negative-temperature-coefficient thermistors each having a structure shown in any of FIGS. 1 to 5.

While preferred embodiments of the invention have been described above, it is to be understood that variations and modifications will be apparent to those skilled in the art without departing the scope and spirit of the invention. The scope of the invention, therefore, is to be determined solely by the following claims.

What is claimed is:

1. A chip thermistor comprising:
a chip element assembly having a substantially rectangular shape and first, second and third pairs of side surfaces facing each other, respectively; and
a pair of external electrodes each having a main electrode portion and a side-surface electrode portion;
wherein the pair of external electrodes have gaps therebetween, each main electrode portion is disposed on each of the first pair of the side surfaces having a substantially rectangular shape, each side-surface electrode portion is disposed on an end portion of each of the four side surfaces which define the second and third pairs of side surfaces, the end portion being connected with each of the first pair of the substantially rectangular side surfaces each having the main electrode portion thereon, and each of the gaps is located on each of the four side surfaces which define the second and third pairs of side surfaces.

2. The chip thermistor according to claim 1, wherein the first pair of the substantially rectangular side surfaces having the main electrode portions thereon each have an area that is larger than that of each of the other two pairs of the side surfaces that define the second and third pair of side surfaces.

3. The chip thermistor according to claim 1, wherein the external electrodes each have a base electrode and a soldering electrode disposed thereon.

4. The chip thermistor according to claim 3, wherein the base electrode is partially exposed at the end of the soldering electrodes.

5. The chip thermistor according to claim 3, wherein the base electrode has ohmic contact and does not have solder wettability.

6. The chip thermistor according to claim 3, wherein the soldering electrode has solder wettability.

7. A chip thermistor mounting structure comprising:
a circuit board having a connection land; and
a chip thermistor according to claim 1 having external electrodes.

8. A chip thermistor mounting structure according to claim 7, wherein the external electrodes are electrically connected to the connection land, such that at least one of the four side surfaces defining the second and third pairs of side surfaces is connected to the connection land, and the four side surfaces defining the second and third pairs of side surfaces are connected with both of the first pair of substantially rectangular side surfaces on which the main electrode portions are disposed.

9. The chip thermistor according to claim 1, wherein the first pair of the side surfaces have a length that is greater than at least one of the second pair of side surfaces and the third pair of side surfaces.

10. The chip thermistor according to claim 1, wherein the first pair of the side surfaces have a length that is substantially equal to one of the second pair of side surfaces and the third pair of side surfaces.

11. The chip thermistor according to claim 9, wherein each of the main electrode portions cover an entire area of the first pair of the side surfaces, respectively.

12. The chip thermistor according to claim 1, wherein the first and second pairs of side surfaces include four longer substantially rectangular side surfaces and the third pairs of side surfaces include two substantially square side surfaces.

13. The chip thermistor according to claim 1, wherein each of the gaps located on each of the four side surfaces which define the second and third pairs of side surfaces is about 0.2 mm.

14. The chip thermistor according to claim 1, wherein the external electrodes have a thickness of about 10 μm or less.

15. The chip thermistor according to claim 3, wherein gaps are provided between the base electrodes and between the soldering electrodes.

16. The chip thermistor according to claim 15, wherein the gap between the base electrodes is about 0.1 mm.

17. The chip thermistor according to claim 15, wherein the gap between the soldering electrodes is about 0.2 mm.

18. A chip thermistor comprising:
a chip element assembly having first, second and third pairs of side surfaces facing each other, respectively, the first pair of side surfaces being longer than at least one of the second and third pair of side surfaces; and
a pair of external electrodes each having a main electrode portion and a side-surface electrode portion;
wherein the pair of external electrodes have gaps therebetween, each main electrode portion is disposed on each of the first pair of the side surfaces so as to cover an entire area of the first pair of the side surfaces, each side-surface electrode portion is disposed on an end portion of each of the four side surfaces which define the second and third pairs of side surfaces, the end portion being connected with each of the first pair of side surfaces each having the main electrode portion thereon, and each of the gaps is located on each of the four side surfaces which define the second and third pairs of side surfaces.

19. The chip thermistor according to claim 18, wherein the first pair of the side surfaces having the main electrode portions thereon each have an area that is larger than that of each of the other two pairs of the side surfaces that define the second and third pair of side surfaces.

20. A chip thermistor mounting structure comprising:
a circuit board having a connection land; and
a chip thermistor according to claim 18 having external electrodes.
